(19) United States
(12) Patent Application Publication
(10) Pub. No.: US 2024/0169295 A1
(43) Pub. Date: May 23, 2024

(54) HOLISTIC VIEW USER INTERFACE FOR VISUALIZING PROCESS COMPLETION TIMELINES

(71) Applicant: MORGAN STANLEY SERVICES GROUP INC., New York, NY (US)

(72) Inventors: Motty Paul Mathews, Leander, TX (US); Vinod Gulani, Bronx, NY (US); Sekhar Pasupulati, Bengaluru (IN); Alanna Benderly, New York, NY (US); Cedric Majeau, Longueull (CA)

(73) Assignee: MORGAN STANLEY SERVICES GROUP INC., New York, NY (US)

(21) Appl. No.: 17/992,922

(22) Filed: Nov. 22, 2022

(51) Int. Cl. G06Q 10/06

(52) U.S. Cl. CPC G06Q 10/06393; G06Q 10/063114

(57) ABSTRACT

A system and method for tracking, visualizing, and automatically responding to the completion or delay of multiple processes is disclosed. The method involves periodically tracking a plurality of milestones associated with performance of an electronic process by consulting at least two distinct forms of data source that are updated during progress or completion of the milestones; receiving filtering attributes and selecting a subset of the plurality of milestones to display based at least in part on the filtering attributes; generating a user interface that displays the milestones along a timeline, each milestone being associated with at least one service level agreement (SLA) visually displayed on the timeline with the milestone; and in response to determining that a milestone has completed at a time after the at least one SLA associated with the milestone, generate an electronic transmission that causes an alert to be displayed to a human operator.

### FIELD OF INVENTION

This disclosure relates to systems and methods for visualizing complex database query results, and more specifically, to systems and methods for generating a graphical user interface that displays summary, statistical, or current incident data for a multitude of processes that are being performed and monitored.

### BACKGROUND

In any large organization or enterprise, there are often countless tasks or processes being performed under very tight time constraints, with certain upstream portions of the task or process being completed before other downstream portions of the task or process can be begun or completed. For example, an automobile factory may require that a delivery truck with new parts arrive by midnight, so that the truck can be fully unloaded by 1:00 AM, so that assembly of the automobiles can be completed by 6:00 AM, so that the finished automobiles can be delivered to a dealership by 8:00 AM. For another example, a data processing organization may require that a file be uploaded by 9:00 PM, so that a batch process can begin running by 11:00 PM, so that a data report can be generated by midnight, and that report can be distributed to a number of recipients by 6:00 AM.

If there are a sufficient number of these overlapping or connected processes being performed simultaneously, it can be virtually impossible for a human overseer to get a sense of how well tasks are proceeding, how far they are falling behind, and whether delays are significant. Even if a monitoring system generates alerts such as “Process #1 is running five minutes late” and “Process #2 is running two hours late”, there may not be any indication that Process #1 is an absolutely mission-critical task that will bring an organization's operations to a halt due to the number of other tasks that depend upon it, while Process #2 is of sufficiently low priority that no intervention is needed unless the delay is even longer.

Thus, there are advantages to having a system that distills the total amount of information available to an operator into a simpler interface for tracking process completion and facilitating intervention if the operator must act.

### SUMMARY OF THE INVENTION

In order to address the limitations of previous visualization software for determining process completion status, a new system for obtaining data, calculating statistics, generating visualizations, and alerting users is disclosed.

The software provides a visualization of various sequential milestones along a timeline, including when completion was expected/required, when completion actually occurred, and other metrics. The software also provides functionality to subscribe to alerts when processes begin, complete, and/or breach their timing expectations, in addition to other events.

As a result, even if a large organization that may have as many as 8,000 processes running daily, and over 2,000 more that run on a weekly, monthly, or other schedule, the flow of events and data may be kept manageable. The software may allow operators to filter the visualized data based on process status, lateness, and internal classifications such as process ID, application, or department. After applying the filter, an operator can visualize the status of each process and efficiently triage responses when processes are exceeding their expected or allotted run time. The visualization can also show upcoming processes that have not yet begun, as well as downstream processes that have a connection to upstream processes, based on requiring output from the upstream processes or otherwise being multiple milestones within a larger overall process.

A system for tracking, visualizing, and automatically responding to the completion or delay of one or more electronic processes is disclosed. The system comprises a milestone tracking database for storing data on a plurality of milestones associated with performance of an electronic process; a scheduling module directing multiple other modules to interface with at least two distinct forms of data source that are updated during progress or completion of the milestones; a message queue for receiving status updates from the other modules; and a consumer module for processing messages from the message queue. Software instructions, when executed by one or more processors, cause one or more processors to use the scheduler module and consumer module, periodically track the plurality of milestones associated with performance of an electronic process by consulting at least two distinct forms of data source that are updated during progress or completion of the milestones. The software receives one or more filtering attributes and selects a subset of the plurality of milestones to display based at least in part on the one or more filtering attributes. The software generates a user interface that displays the milestones from the selected subset along a timeline, each milestone being associated with at least one service level agreement (SLA) for that milestone visually displayed on the timeline with the milestone. Finally, in response to determining that a milestone has completed at a time after the at least one SLA associated with the milestone, the software generates an electronic transmission that causes an alert to be displayed to a human operator.

Similarly, a computer-implemented method for tracking, visualizing, and automatically responding to the completion or delay of one or more electronic processes is disclosed. The method comprises periodically tracking a plurality of milestones associated with performance of an electronic process by consulting at least two distinct forms of data source that are updated during progress or completion of the milestones; receiving one or more filtering attributes and selecting a subset of the plurality of milestones to display based at least in part on the one or more filtering attributes; generating a user interface that displays the milestones from the selected subset along a timeline, each milestone being associated with at least one service level agreement (SLA) for that milestone visually displayed on the timeline with the milestone; and in response to determining that a milestone has completed at a time after the at least one SLA associated with the milestone, generating an electronic transmission that causes an alert to be displayed to a human operator.

Additional features include variations of the above system and method wherein
the at least one SLA for each milestone comprises at least one soft SLA completion time and at least one hard SLA completion time following the soft SLA completion time;
machine learning techniques are used to identify a possible future SLA breach for a milestone that has not yet completed one or more additional user interfaces are generated and displayed to show historical delay results in one or more milestones during a past interval in time;
dependencies are identified between an upstream milestone and a downstream milestone, and the user interface indicates that a delay in completion of a downstream milestone is due to lack of completion of an upstream milestone.
additional alerts are generated and provided to a human operator, warning that a downstream milestone will be delayed or breach an SLA because of an upstream milestone's delay or breach;
additional alerts may be generated and provided to a human operator based on a subscription made by the human operator to one or more status changes;
the user interface comprises dynamic zoom functionality to change a duration of time visualized; and/or
the periodic tracking occurs based at least in part on inclusion and exclusion calendars that indicate days on which milestones are or are not expected to be completed, respectively.

### BRIEF DESCRIPTION OF THE DRAWINGS

Other aspects, features and advantages will become more fully apparent from the following detailed description, the appended claims, and the accompanying drawings (provided solely for purposes of illustration without restricting the scope of any embodiment), of which:

FIG. 1 illustrates, in simplified form, a system of computing devices used to aggregate process status data for generation of a user interface to interact with the data;

FIG. 2 illustrates, in simplified flowchart form, a method of determining the current status of an ongoing or completed process;

FIG. 3 illustrates, in simplified flowchart form, a method of obtaining information regarding the current status of multiple ongoing or completed processes;

FIG. 4 depicts an example user interface for showing multiple ongoing or completed processes in a timeline;

FIGS. 5A, 5B, and 5C depict use of the user interface of FIG. 4 to zoom in on a particular portion of the timeline;

FIG. 6 depicts an example user interface for displaying statistics regarding the status of processes for a particular window of time;

FIG. 7 depicts an example user interface for displaying historical trends regarding the outcome of processes;

FIG. 8 illustrates, in simplified flowchart form, a method of using machine learning to predict future breaches by processes depending on current conditions; and

FIG. 9 is a high-level block diagram of a representative computing device that may be utilized to implement various features and processes described herein.

### DETAILED DESCRIPTION OF THE DRAWINGS

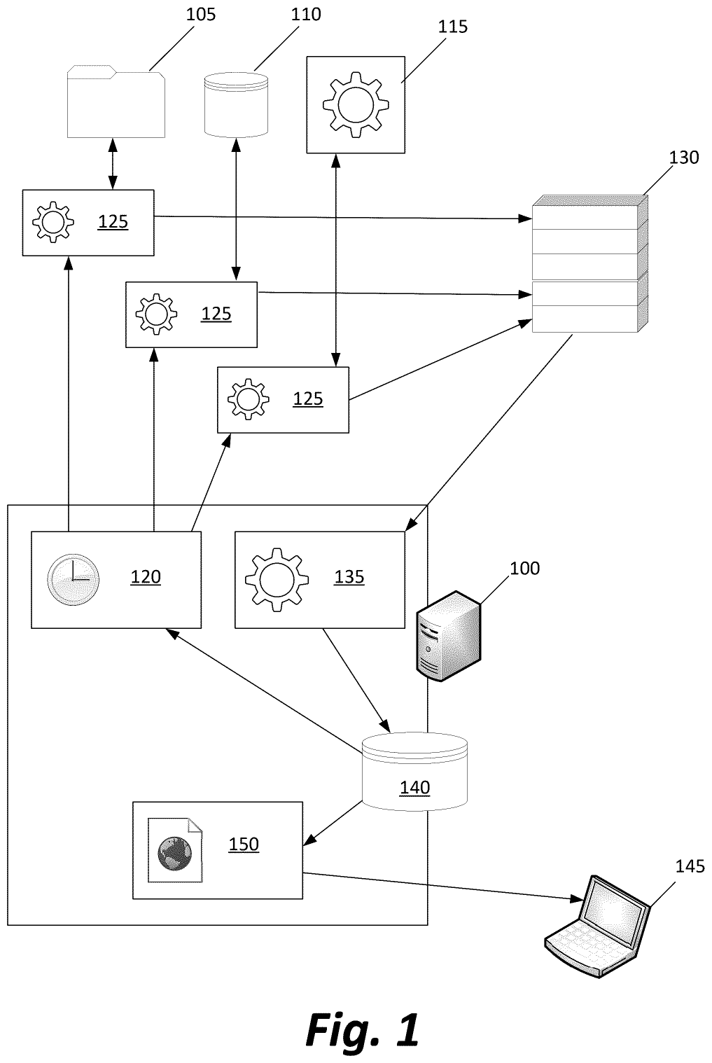

FIG. 1 illustrates, in simplified form, a system of computing devices used to aggregate process status data for generation of a user interface to interact with the data.

A central server 100 may be used to retrieve data from a variety of sources, including, preferably, one or more data stores 105, one or more databases 110, and one or more job schedulers 115.

The data store(s) 105 may be, for example, a folder in a server share, a folder on the server 100 itself, a remote FTP server, a data lake in an Amazon S3 storage bucket, or any other place that files might be stored. The database(s) 110 may be, for example, a SQL-based database, data storage for files in another tabular format such as comma separated value text files, data storage for files in a non-tabular format such as XML or JSON, or any other means for storing records. The job scheduler(s) 115 may be, for example, Autosys, a cron job scheduler, a custom batch script, or any other means of triggering software execution at a certain moment in time.

In other embodiments, there may be additional data sources, such as the stored outcome of a routinely repeated query in SQL, Splunk, or another querying language acting upon a tabular or non-tabular data source, or an API used by a web app or other software to message the central server and provide data on an event.

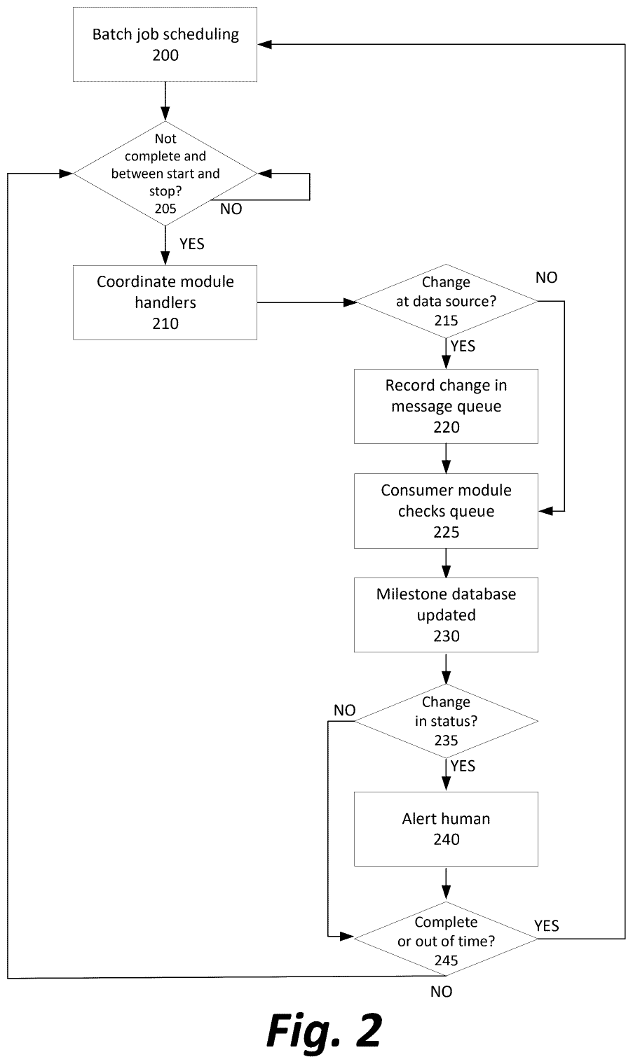

A scheduler module 120, which is either executed by the server 100 or triggered by it to execute on another computing device, routinely cycles through all of the milestones to search for those that are both pending and have not yet expired due to a duration elapsing without having completed. At a predetermined frequency set for each such milestone, the scheduler module schedules a number of module handlers 125 to interact with the data sources 105, 110, and 115, in accordance with a method depicted in FIG. 2 and described more fully below.

In a preferred embodiment, the module handlers 125 output results into a message queue 130, such as an Apache Kafka queue or other storage for messages.

A consumer module 135, which is also either executed by the server 100 or triggered by it to execute on another computing device, reads the messages from the message queue 130 and update records in a milestone database 140.

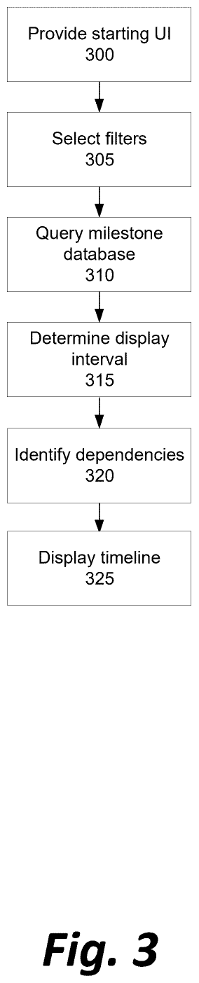

Ultimately, one or more client computing devices 145 (preferably desktop or laptop computers, but possibly mobile phones, smart watches, or other computing devices) are used to request the data being stored in the milestone database 140. In order to provide it in a useable manner, a backend module 150 queries the milestone database 140 and generates a web app interface to be displayed in a web browser on a client computing device 145, in accordance with a method depicted in FIG. 3 and described more fully below.

Although a particular division of functions between devices is described with relation to the systems depicted in FIG. 1, above, other configurations are possible in which functions are divided among devices differently. For example, all of the functions of some or all of the server 100, the data store(s) 105, the database(s) 110, the job scheduler(s) 115, scheduler module 120, module handlers 125, the message queue 130, the consumer module 135, the milestone database 140, and the backend module 150 might conceivably be performed by a single device with multiple threads executing different software modules simultaneously.

Alternatively, each system or device from among the server 100, the data store(s) 105, the database(s) 110, the job scheduler(s) 115, scheduler module 120, module handlers 125, the message queue 130, the consumer module 135, the milestone database 140, and the backend module 150 may in fact be a cluster of computing devices sharing functionality for concurrent processing. Further, although these various computing elements are described as if they are one computing device or cluster each, a cloud-based solution with multiple access points to similar systems that synchronize their data and are all available as backups to one another may be preferable in some embodiments to a unique set of computing devices all stored at one location. The specific number of computing devices and whether communication between them is network transmission between separate computing devices or accessing a local memory of a single computing device is not so important as the functionality that each part has in the overall scheme.

Milestone Data

In a preferred embodiment, the milestone database 140 stores, for each milestone,
one or more macro-level level milestones and/or applications that a micro-level milestone is associated with,
a frequency with which the milestone progress should be checked while it is in progress,
a “soft service level agreement (SLA)” that represents a preferred time for a process to be completed by in order to ensure smooth operations, as well as the time at which the scheduler module 120 will have the module handlers 125 begin checking whether the milestone has been completed,
a “hard SLA” that represents the mandatory time for the process to be completed,
a duration for the milestone, such that the maximum time to keep checking whether the milestone has been completed (or the “stop time”) is equal to the soft SLA plus the duration (e.g., if the duration is 120 minutes and the soft SLA is set at 8:00 AM, the scheduler 120 will not schedule module handler 125 events after 10:00 AM, and the module handlers will return a final “not completed” status that will be stored in the milestone database 140)
the time zone with respect to which the soft SLA and hard SLA are being considered,
a daily run schedule, and
an exclusion or inclusion calendar.

The daily run schedule value may represent, for example, “Monday-Friday” or “Monday-Saturday” to represent that it is run on business days, “Tuesday-Saturday” or “Tuesday-Sunday” (if a process is doing cleanup after each workday), “Sunday-Thursday” or “Sunday-Friday” (if a process is doing preparatory work before each workday), or a more exotic set of days of the week. An exclusion calendar may augment the daily run schedule by indicating the set of days on which a process is not run, regardless of day of week, such as federal holidays, bank holidays, or other events that may take precedence annually or at a different level of frequency. Similarly, an inclusion calendar may augment or replace the daily run schedule by indicating a set of days on which the process must be run regardless of day of week, such as on the first day of each month, last day of each quarter, on a biweekly basis, or any other way of expressing the times at which the process must be run.

While the above information can be stored generically for all instances of the milestone, the milestone database 140 also stores each specific instance of the milestone that will be run, along with its current status (“Not started”, “In progress”, “Error”, “Failed”, “Not completed”, “Completed”, etc.), the actual completion time, if applicable, the timestamps of the soft SLA and hard SLA (computed based on the stored running schedule and inclusion/exclusion calendar) and whether the hard SLA was breached by that completion time.

So, for example, while the generic information regarding a milestone may indicate that it has a hard SLA of 8:00 PM and runs on Monday-Friday, a specific instance of the milestone may indicate that it was meant to be finished by 8:00 PM on Monday, January 1, yet did not complete until 8:05 PM on that day, and therefore has the statuses of “Completed” and “Breached.”

The milestone database 140 may also contain a table for expressing dependency relationships between milestones, such that one downstream milestone always depends on completion of an upstream milestone. This information may also be used for visualization or analysis purposes, as described further below.

Building the Data for Visualization

FIG. 2 illustrates, in simplified flowchart form, a method of determining the current status of an ongoing or completed process.

First, a batch job runs every day to determine what the next day for every milestone should be (Step 200), based on the milestone's daily schedule and inclusion or exclusion calendars. For example, if the batch job is running on Friday evening for a milestone that normally executes on Monday-Friday mornings, the daily schedule and exclusion/inclusion calendars will be consulted to determine whether the scheduled module handler events should be for Monday morning, or instead for Tuesday morning (due to an exclusion calendar noting that Monday is a business holiday) or earlier than Monday (for example, due to an inclusion calendar indicating that a process should be performed on the first of the month, even if that day is a weekend). The batch job creates a record in the milestone database 140 indicating that the milestone should have a given soft SLA, hard SLA, and duration as absolute timestamps instead of as a general day or time of day (i.e., “Monday at 1 AM” becomes the timestamp representing 1:00 AM EST on Monday, Jan. 1, 2023.)

The scheduler module 120 is perpetually running with respect to every milestone, checking whether there exists a milestone in the milestone database 140 that has the status of “not completed”, whether the current time is after the soft SLA, and whether the current time is before the soft SLA plus the duration (Step 205). If so, it coordinates the module handlers 125 to instruct them to check the milestone status after the milestone's interval (Step 210).

At the appointed time, each module handler interacts with its associated data source (Step 215) to determine whether there has been a change that indicates a milestone is beginning, completed, or failed/errored, such as a new file in storage, a new record in a database, or a new message or status code from a scheduled job. If there is a relevant change, the change is recorded in the messaging queue (Step 220). Either way, the consumer module 135 will soon review the queue for new messages (Step 225) and update the milestone database 140 if necessary (Step 230).

The central server 100 will periodically check the milestone database for new changes (Step 235) and alert a human operator if necessary (Step 240). Human operators are permitted to subscribe to one or more event types and receive messages via email, text message, Symphony, Teams, or other communications platforms whenever that event type is noted for a particular application, macro-milestone, or micro-milestone. The operator may subscribe to all events, or only be notified specifically for failed, completed, in progress, and/or not completed events, with or without the “breached” or “not breached” modifier.

When the interval of time between module handling events has passed, and the milestone has still not entered a final status such as “complete”, “failed”, or “not completed [and past the duration for checking]” (Step 245), the scheduler 120 will schedule the next set of module handler events (back to Steps 205 and 210), based on the stored frequency for that milestone. In a preferred embodiment, the frequency is once per five minutes between the beginning and conclusion of the milestone process. If the milestone does have a final status, the scheduler will no longer act on that milestone as it cycles through the milestone database 140, and no further action will occur until after the daily batch job creates a new record for a future instance of the milestone (back to Step 200).

Visualizing the Data

FIG. 3 illustrates, in simplified flowchart form, a method of obtaining information regarding the current status of multiple ongoing or completed processes.

First, a basic user interface is provided to a human operator in a web browser or other interface on the client computing device 145 (Step 300), including a number of possible filters to apply to the milestones, such as a department, app, macro milestone, micro milestone, status, or date range. The human operator selects one or more of the filters (Step 305).

Based on the selected queries, the backend module 150 queries the milestone database 140 as appropriate to obtain all responsive records (Step 310).

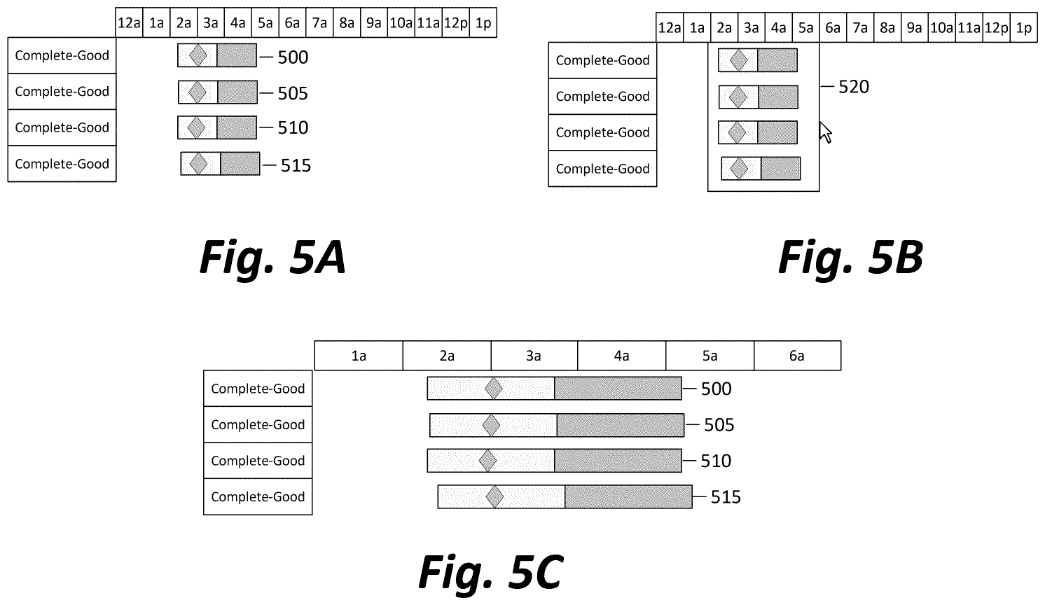

The backend module 150 also determines the interval of time to be displayed in the timeline view (Step 315). By default, the timeline view will show midnight to midnight for the current day, but other factors may override this default, including a current level of zoom (see FIGS. 5A-5C), selection of a date range, shifting of the midnights to another time based on a human operator being in a different time zone from one in which the milestones are performed, or configuration of the system to use a different default range. In some instances, steps 315 and 310 may be reversed in order to determine that some results would not be shown anyway, and need not be retrieved from the milestone database 140.

The backend module 150 also consults the milestone database 140 to determine the existence of dependencies (Step 320) among milestones being displayed. If a dependency does exist, the timeline view may group milestones together to show the waterfall of how one milestone cannot be completed before a previous milestone. Other visual indicators such as arrows or colors may be used to show this connection, and may be modified if the connection is causing a downstream delay. For example, a milestone that might normally be shown in an ordinary gray or blue may instead begin flashing yellow if it should have started already, but cannot because an upstream milestone is delayed or in breach, and may begin flashing orange or red in response to passing the soft SLA or hard SLA point due to an upstream milestone in breach. As a consequence, a human operator will know that any software or human error problem is not with the downstream milestone, but with the upstream milestone preventing progress.

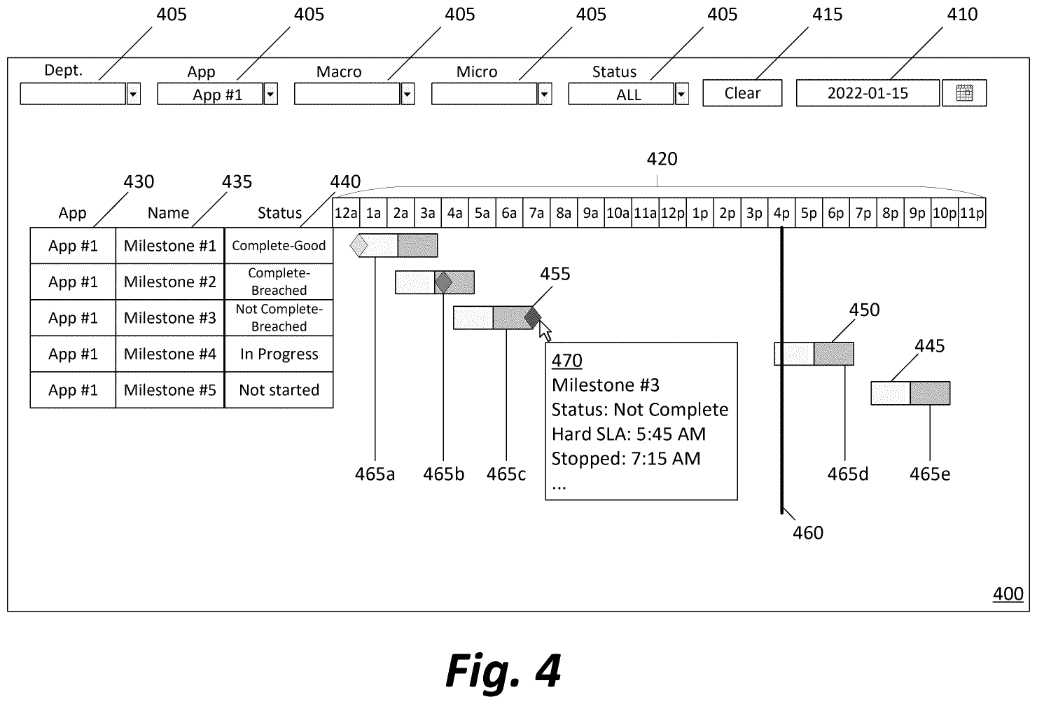

After all data has been retrieved, the milestones are displayed on the timeline (Step 325) as shown in FIG. 4. Color, texturing, and other visual features may be employed to indicate current status, beginnings and endings of time intervals, or dependencies, as described below.

FIG. 4 depicts an example user interface for showing multiple ongoing or completed processes in a timeline.

The user interface 400 includes, as mentioned, a number of drop down filters 405, including by way of non-limiting example, department, application, macro milestone, micro milestone, or status. There is also the ability to select a date range 410 or to clear all currently active filters 415. A time axis 420 shows the currently displayed time interval, while a number of milestones 425 are displayed perpendicular to the time axis. The milestones may be grouped by app, department, or other factors 430, have a displayed name 435, a current status 440, and a visual representation of the soft SLA 445, hard SLA 450, and completion time indicator 455, if any. A line representing the present 460 (as depicted, approximately 4:30 PM) may be used to show which milestones are in the past and which are yet to come.

Color, texturing, or other visual features may be used to show whether a status is completed, in progress, or failed/errored, as well as whether the ultimate outcome represented a breach. In some embodiments, these colors may be chosen from palettes with intuitive contextual meanings (such as green for “good/acceptable”, yellow for “pending/warning/caution”, orange for “problematic/increased risk”, red for “danger/failure”, etc.) to aid a human reviewer in quickly identifying and triaging problems. In other embodiments, there may be options for a user to customize coloration (for example, introducing blue or purple to indicate particular outcomes of interest to that user), or for alternative palettes to be selected in response to color-blindness, diminished ability to sense contrast, or other medical or cognitive considerations, and which reduce the likelihood that a user with some sort of disability will be unable to distinguish between statuses. These colorations apply primarily to the completion time indicators 455 and to other UI elements related to status/outcomes. In a preferred embodiment, the soft SLA and hard SLA indicators 445 and 450 are different shades of completely desaturated gray, in order to set these rectangles apart from the background and from other UI elements without overpowering them with bright coloration. Again, in alternative embodiments, it may be preferred to select other colorations for considerations of contrast (for vision impaired users) or significance (for example, a desaturated yellow for the soft SLA and a desaturated red for the hard SLA, to intuitive demonstrate the increasing concern). Alternatively, instead of coloration, a texturing like cross-hatching, stripes, polka-dotting, or similar patterns may be applied instead of relying on a solid coloration.

In a preferred embodiment, the completion time indicator 455 is a diamond/rhombus. This shape has two advantages over other possible indicator shapes. First, unlike a line or point, it has an area; this makes it more visible because it takes up more of the screen, and allows it to be further distinguished from overlapping elements like the SLA indicators by a contrasting border. Second, unlike a circle, axis-aligned square, or most other polygons, the diamond will come to a sharp point at both the top and bottom of the indicator. These points correspond to an exact moment on the time axis 420 and do not require a viewer to judge where the center of the polygon is in order to estimate the timestamp it represents. Although the same effect could be achieved by a hexagon, octagon, or other regular 2n-gon, a diamond offers the cleanest user interface. A triangle, pentagon, or other regular 2n+1-gon could have a point indicator at either the top or the bottom, but not both.

For example, a first milestone 465a may use a light green diamond to indicate completion of the milestone at around 1 AM during the soft SLA period, depicted in a lighter gray. The soft SLA period begins at the moment when the soft SLA is supposed to have been met, and ends at the moment when the hard SLA is in effect. A second milestone 465b may use a dark green diamond to indicate completion of the milestone at around 4 AM, during the hard SLA period, depicted in a darker gray, indicating a breach, though a minor one. The hard SLA period begins at the moment when the hard SLA was supposed to have been met, and ends at the time represented by the soft SLA plus the milestone duration. A third milestone 465c may use an orange diamond to indicate that the milestone never completed before the hard SLA period ended at approximately 7:15 AM, when the full duration ended for that milestone, and the module handlers stopped checking for completion of the milestone. A fourth milestone and fifth milestone 465d and 465e may not have any diamond, to indicate that there is not a fixed completion time yet, though one started at around 4:15 PM, and the other is entirely in the future and not intended to start until noon.

A tooltip popup window 470 may be included to allow additional information to be displayed when a cursor or other input device passes over or otherwise interacts with the soft SLA 445, hard SLA 450, or completion time indicator 455. The tooltip 470 that is depicted only shows the milestone name, status, hard SLA time, and the time that checking stopped because the duration had passed, but in other embodiments, many more forms of information could be displayed, including a process's department, associated application or product, dependencies, frequency of checking before the duration, and so on.

In embodiments that do not rely on coloration, the shape of the completion time indicator may vary from diamond to other shapes to show a status, or shading, hatching, or other texturing may be applied in addition to or instead of color.

FIGS. 5A, 5B, and 5C depict use of the user interface of FIG. 4 to zoom in on a particular portion of the timeline.

First, in FIG. 5A, a set of milestones 500, 505, 510, and 515 are all displayed on a scale that shows multiple hours of time in the horizontal axis. Because there are very minute distinctions between the milestone completion times, it may be very difficult for a human operator to tell at a glance in what order the milestones were completed.

However, the operator is able to dynamically change the time scale displayed to make visual review simpler. In FIG. 5B, the operator uses a cursor (or finger on a touchscreen, or other input device) to select a region 520 of the timeline having a relatively short duration and containing the completion times of each of the milestones 500, 505, 510, and 515. As depicted, the operator focuses in on the period of time between 2 AM and 6 AM.

In response, as depicted in FIG. 5C, the view updates to stretch out along the time axis and focus on the region 520 that was selected, omitting any milestone data outside of the selected region but allowing for greater differentiation between times within the selected region. It is now easier to see that, even though all four completions are still clustered around 3 AM, the third milestone 510 was completed first, followed by the second milestone 505, followed by the first milestone 500, with the fourth milestone 515 being the last to complete.

Other Statistical Review

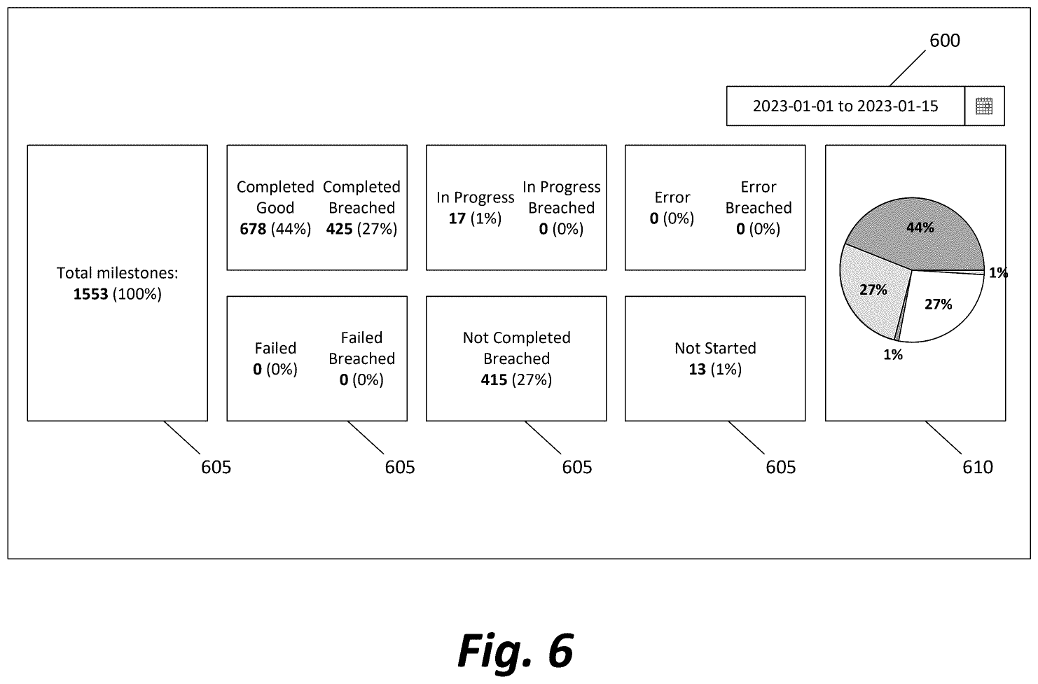

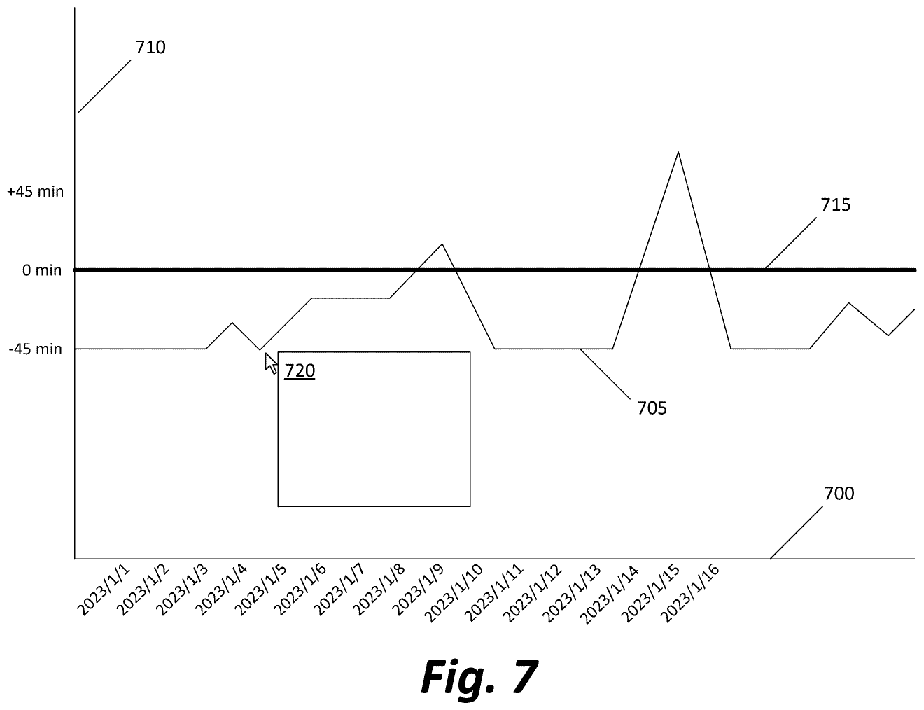

Other user interfaces may be incorporated to allow human operators to more easily process past milestone statistics and adopt appropriate responses to trends of failures or breaches. FIGS. 6 and 7 depict two such user interfaces.

FIG. 6 depicts an example user interface for displaying statistics regarding the status of processes for a particular window of time.

A user interface may be provided that queries historical data in the milestone database 140 and, for a specified time interval 600, selects all milestones that were completed or attempted during the interval. The interface then displays absolute numbers 605 of milestones in total and by status, as well as the relative proportion of each milestone type as a fraction or percentage. A pie chart 610 or other graph type may also be used to show status outcomes during the specified time interval.

FIG. 7 depicts another example user interface for displaying historical trends regarding the outcome of processes.

In this alternative user interface, a timeline is displayed over a series of days along a first axis 700, so that the outcomes of multiple instances of a daily milestone may be displayed (line 705). The second axis 710 represents how early or late the milestone was completed with respect to an SLA for the milestone, with a line 715 representing that SLA. Mousing over the milestone line 705 at any point may show a pop up window 720 with the date currently being examined, the lateness or earliness of the completion of the milestone on that date, and other information about that milestone completion. As a result, the human operator can quickly identify whether the trend is towards promptness and fewer breaches or delay and more breaches. For example, as depicted here, a human operator can instantly tell that the displayed milestone has been generally met over the past few weeks, but that there was an instance of breach on January 9, as well as a severe slowdown and breach around January 15.

Future Prediction

In addition to human analysis of past and current performance to address breaches before or as they happen, it is preferable to supplement with machine learning techniques to predict future breaches based on current states with cues too subtle for a human to identify.

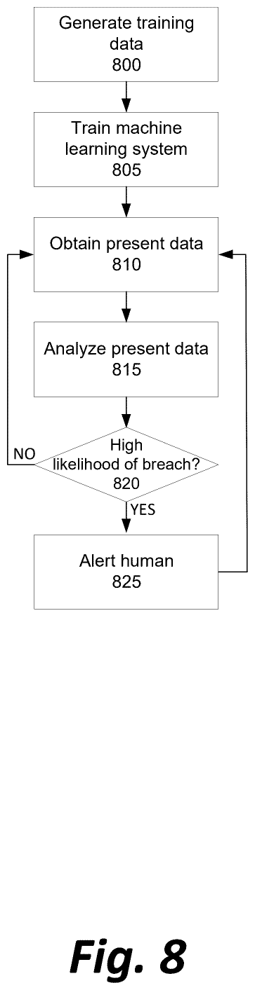

FIG. 8 illustrates, in simplified flowchart form, a method of using machine learning to predict future breaches by processes depending on current conditions.

Various means are known in the art for training an artificial intelligence to classify or quantify a discrete input, such as k-means clustering, logistical regression, or neural networks. Training data for any of these methods may be generated (Step 800) by vectorizing various states of milestones and associating them with the ultimate outcome of that milestone or other milestones. For example, if at a given moment in time, Milestone #1 was running five minutes late, Milestone #2 was running ten minutes late, and Milestone #3 was on time, but an hour later, Milestone #3 nonetheless ended five minutes in breach, a training vector containing the scalars [5, 10, 0] and associating with the outcome [5] may be used to train one or more of the machine learning systems described (Step 805). For example, k-means clustering may be used to cluster similar vectors that all had a breach outcome, and a similarity with those vectors in the present may indicate a future breach outcome. Logistical regression may be used to convert a present state vector into a probability from 0 to 1 that the present state will lead to breach, based on a linear transformation of the vector contents. Neural networks may make a sophisticated prediction, based on dozens or hundreds of input variables, whether a given milestone's SLA will be breached.

After training, present state vectors may be obtained routinely from the milestone database 140 (Step 810), clustered or otherwise processed by the machine learning system (Step 815), and in response to a high probability of breach or clustering with other breaches (Step 820), an alert may be generated and provided to a human operator to indicate the possible future problem (Step 825). After either sending the alert or determining that there is no cause for concern, the machine learning technique tries again as soon as the data regarding current milestone state has had a chance to update (back to step 810).

Computing Devices Generally

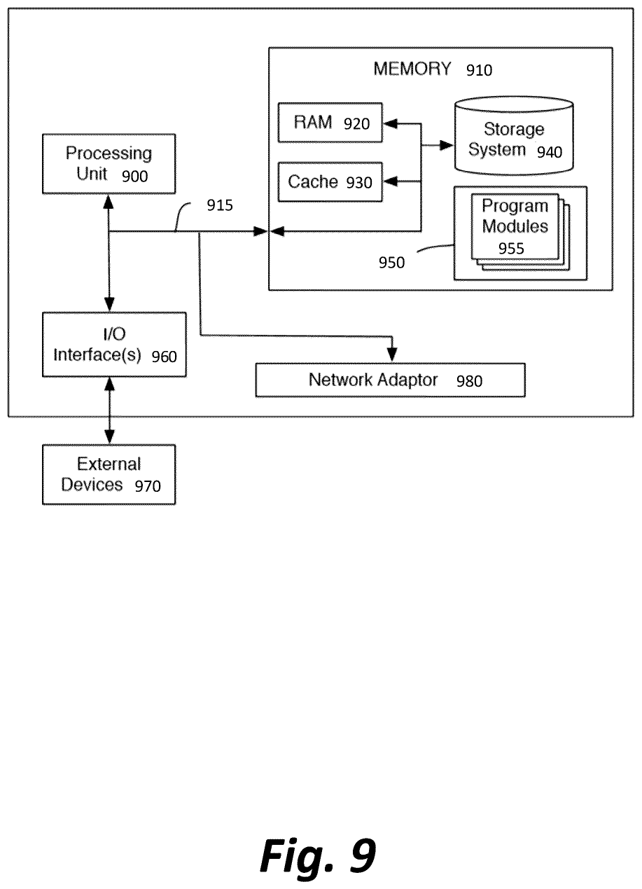

Although FIG. 1 depicts a preferred configuration of computing devices and software modules to accomplish the software-implemented methods described above, those methods do not inherently rely on the use of any particular specialized computing devices, as opposed to standard desktop computers and/or web servers. For the purpose of illustrating possible such computing devices, FIG. 9, below, describes various enabling devices and technologies related to the physical components and architectures described above.

FIG. 9 is a high-level block diagram of a representative computing device that may be utilized to implement various features and processes described herein, for example, the functionality of the server 100, the data store(s) 105, the database(s) 110, the job scheduler(s) 115, scheduler module 120, module handlers 125, the message queue 130, the consumer module 135, the milestone database 140, the client computing device(s) 145, and the backend module 150, or any other computing device described. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 9, the computing device is illustrated in the form of a special purpose computer system. The components of the computing device may include (but are not limited to) one or more processors or processing units 900, a system memory 910, and a bus 915 that couples various system components including memory 910 to processor 900.

Bus 915 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 900 may execute computer programs stored in memory 910. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 900 may be used.

The computing device typically includes a variety of computer system readable media. Such media may be any available media that is accessible by the computing device, and it includes both volatile and non-volatile media, removable and non-removable media.

System memory 910 can include computer system readable media in the form of volatile memory, such as random access memory (RAM) 920 and/or cache memory 930. The computing device may further include other removable/non-removable, volatile/non-volatile computer system storage media. By way of example only, storage system 940 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 915 by one or more data media interfaces. As will be further depicted and described below, memory 910 may include at least one program product having a set (e.g., at least one) of program modules that are configured to carry out the functions of embodiments described in this disclosure.

Program/utility 950, having a set (at least one) of program modules 955, may be stored in memory 910 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 970 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 960.

In addition, as described above, the computing device can communicate with one or more networks, such as a local area network (LAN), a general wide area network (WAN) and/or a public network (e.g., the Internet) via network adaptor 980. As depicted, network adaptor 980 communicates with other components of the computing device via bus 915. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for tracking, visualizing, and automatically responding to the completion or delay of one or more electronic processes, comprising:
a milestone tracking database for storing data on a plurality of milestones associated with performance of an electronic process;
a scheduling module directing multiple other modules to interface with at least two distinct forms of data source that are updated during progress or completion of the milestones;
a message queue for receiving status updates from the other modules;
a consumer module for processing messages from the message queue; and
non-transitory memory comprising instructions that, when executed by one or more processors, cause one or more processors to:
using the scheduler module and consumer module, periodically track the plurality of milestones associated with performance of an electronic process by consulting at least two distinct forms of data source that are updated during progress or completion of the milestones;
receive one or more filtering attributes and select a subset of the plurality of milestones to display based at least in part on the one or more filtering attributes;
generate a user interface that displays the milestones from the selected subset along a timeline, each milestone being associated with at least one service level agreement (SLA) for that milestone visually displayed on the timeline with the milestone; and
in response to determining that a milestone has completed at a time after the at least one SLA associated with the milestone, generate an electronic transmission that causes an alert to be displayed to a human operator.

2. The system of claim 1, wherein the at least two distinct forms of data source include a folder or data store into which files are inserted, a database into which records are inserted, and a job scheduler that reports results of jobs as they are executed.

3. The system of claim 1, wherein the instructions, when executed, further cause the one or more processors to:
use machine learning techniques to identify a possible future SLA breach for a milestone that has not yet completed: and
in response to identifying the possible future SLA breach, generate an electronic transmission that causes an alert to be displayed to a human operator.

4. The system of claim 1, wherein the user interface comprises dynamic zoom functionality to change a duration of time visualized.

5. The system of claim 1, wherein the periodic tracking occurs based at least in part on inclusion and exclusion calendars that indicate days on which milestones are or are not expected to be completed, respectively.

6. The system of claim 1, wherein additional alerts may be generated and provided to a human operator based on a subscription made by the human operator to one or more status changes.

7. The system of claim 1, wherein the periodic tracking identifies dependencies between an upstream milestone and a downstream milestone, and wherein the user interface indicates that a delay in completion of a downstream milestone is due to lack of completion of an upstream milestone.

8. The system of claim 7, wherein an additional alert is generated and provided to a human operator, warning that a downstream milestone will be delayed or breach an SLA because of an upstream milestone's delay or breach.

9. The system of claim 1, wherein one or more additional user interfaces are generated and displayed to show historical delay results in one or more milestones during a past interval in time.

10. The system of claim 1, wherein the at least one SLA for each milestone comprises a soft SLA completion time, a hard SLA completion time following the soft SLA completion time, and a predefined duration of time after the soft SLA completion time, representing a maximum process stop time.

11. The system of claim 10, wherein the soft SLA completion time, hard SLA completion time, and maximum process stop time for each milestone are displayed along the timeline in the user interface by means of two desaturated rectangles that connect the soft SLA completion time to the hard SLA completion time and the hard SLA completion time to the maximum process stop time, respectively.

12. The system of claim 10, wherein a rhombic completion indicator is displayed along the timeline, indicating, for every milestone that is either complete or past its maximum process stop time, the time of completion or of reaching that maximum process stop time.

13. The system of claim 13, wherein the rhombic completion indicator and other UI elements are colored according to a predetermined palette to demonstrate completion status or other attributes of a milestone.

14. A computer-implemented method for tracking, visualizing, and automatically responding to the completion or delay of one or more electronic processes, comprising:
periodically tracking a plurality of milestones associated with performance of an electronic process by consulting at least two distinct forms of data source that are updated during progress or completion of the milestones:
receiving one or more filtering attributes and selecting a subset of the plurality of milestones to display based at least in part on the one or more filtering attributes:
generating a user interface that displays the milestones from the selected subset along a timeline, each milestone being associated with at least one service level agreement (SLA) for that milestone visually displayed on the timeline with the milestone: and
in response to determining that a milestone has completed at a time after the at least one SLA associated with the milestone, generating an electronic transmission that causes an alert to be displayed to a human operator.

15. The method of claim 14, wherein the at least two distinct forms of data source include a folder or data store into which files are inserted, a database into which records are inserted, and a job scheduler that reports results of jobs as they are executed.

16. The method of claim 14, further comprising:
using machine learning techniques to identify a possible future SLA breach for a milestone that has not yet completed: and
in response to identifying the possible future SLA breach, generating an electronic transmission that causes an alert to be displayed to a human operator.

17. The method of claim 14, wherein the user interface comprises dynamic zoom functionality to change a duration of time visualized.

18. The method of claim 14, wherein the periodic tracking occurs based at least in part on inclusion and exclusion calendars that indicate days on which milestones are or are not expected to be completed, respectively.

19. The method of claim 14, wherein additional alerts may be generated and provided to a human operator based on a subscription made by the human operator to one or more status changes.

20. The method of claim 14, wherein the periodic tracking identifies dependencies between an upstream milestone and a downstream milestone, and wherein the user interface indicates that a delay in completion of a downstream milestone is due to lack of completion of an upstream milestone.

21. The method of claim 20, wherein an additional alert is generated and provided to a human operator, warning that a downstream milestone will be delayed or breach an SLA because of an upstream milestone's delay or breach.

22. The method of claim 14, wherein one or more additional user interfaces are generated and displayed to show historical delay results in one or more milestones during a past interval in time.

23. The method of claim 14, wherein the at least one SLA for each milestone comprises a soft SLA completion time, a hard SLA completion time following the soft SLA completion time, and a predefined duration of time after the soft SLA completion time, representing a maximum process stop time.
